(19) United States
(12) Patent Application Publication
(10) Pub. No.: US 2014/0206345 A1
(43) Pub. Date: Jul. 24, 2014

(54) SCENARIO GENERATION DEVICE AND SCENARIO GENERATION METHOD

(71) Applicant: Anritsu Corporation, Kanagawa (JP)

(72) Inventors: Junya Tanaka, Kanagawa (JP); Yasuyuki Matsuyama, Kanagawa (JP); Takuma Goto, Kanagawa (JP)

(73) Assignee: Anritsu Corporation, Kanagawa (JP)

(21) Appl. No.: 14/100,333

(22) Filed: Dec. 9, 2013

(30) Foreign Application Priority Data
Jan. 18, 2013 (JP) 2013-007929

(51) Int. Cl. H04W 24/10

(52) U.S. Cl. CPC H04W 24/10
USPC 455/425

(57) ABSTRACT

A scenario generation device includes: a system information schedule generation unit that displays, a first transmission schedule setting environment with a table form that includes a plurality of setting fields which correspond to the positions of a plurality of frames that can be allocated to transmission of system information in mobile communication and to which a type name of the system information can be set, receives the type name which is input to the setting field corresponding to the position of the frame selected, and generates a transmission schedule of the system information on the basis of the input result; and a scenario generation unit that generates a test scenario which is used in a pseudo-base station apparatus and in which a communication sequence related to the system information is described on the basis of the transmission schedule of the system information.

### TECHNICAL FIELD

The present invention relates to a scenario generation device and a scenario generation method which create a test scenario used in a test device for testing a mobile communication terminal.

### BACKGROUND ART

In the development of mobile communication terminals, such as mobile phones or mobile devices, a test device which simulates a base station has been used in order to test whether a mobile communication terminal under development can normally communicate with the base station according to the communication standard. The test device stores a test scenario which is created in advance. An operation sequence of the test device or a communication sequence with the mobile communication terminal is described in the test scenario. In a communication test for the mobile communication terminal, the test device operates as a pseudo-base station according to the test scenario, communicates with the mobile communication terminal to be tested, and checks whether communication occurs normally. Therefore, it is also important to develop a scenario generation device that creates a test scenario.

However, in the mobile communication standard, system information is defined as important information which is transmitted from the base station to the mobile communication terminal. The system information includes, for example, the position information of the base station, information about peripheral cells, and information for controlling an outgoing call restriction and is circularly broadcasted to the mobile communication terminal every 128 frames.

For example, in a wideband code division multiple access (W-CDMA) communication system, the system information includes one master information block (MIB) and a plurality of system information blocks (SIBs).

The MIB includes information for notifying the mobile communication terminal of the structure (transmission schedule indicating the relationship between a frame number and the type of SIB) of the SIB which is circularly broadcasted every 128 frames and information for notifying a change in the system information.

There are various types of SIBS, such as SIB1, SIB2, SIB3, . . . . For example, SIB1 is used to notify common information to each group of cells, and SIB2 and the subsequent SIBs are used to notify common information to each cell.

The system information can optionally include a plurality of scheduling blocks (SBs). The SB includes the scheduling information (information of a transmission schedule) of the SIB.

In the W-CDMA system, when transmitting the blocks, such as the MIB, the SIB, and the SB, the base station allocates one block to every other frame and circularly transmits the blocks every 128 frames. The blocks are divided into a block, such as the MIB which is allocated to a fixed position and is allocated a fixed number of times among 128 frames, and a block which can be allocated to an arbitrary position and can be allocated an arbitrary number of times by the communication standard.

Of course, a communication sequence related to the transmission of the system information is included in the test scenario. During a test, each block is circularly transmitted from the pseudo-base station to the mobile communication terminal to be tested, on the basis of the set transmission schedule.

### PRIOR ART DOCUMENT

### Patent Document

[Patent Document 1] Japanese Unexamined Patent Application Publication No. 2008-199085

### DISCLOSURE OF THE INVENTION

### Problem that the Invention is to Solve

However, when a test scenario including system information as a communication sequence is created, for example, the scenario creator needs to describe the communication sequence while checking the transmission schedule of the system information, which is troublesome. In addition, the above-mentioned structure does not disclose means for setting the transmission schedule of the system information with high efficiency.

The invention has been made in view of the above-mentioned problems and an object of the invention is to provide a scenario generation device and a scenario generation method which can generate a system information transmission schedule with high efficiency and improve efficiency in generating a test scenario.

### Means for Solving the Problem

In order to achieve the object, according to an aspect of the invention, a scenario generation device for generating a test scenario used in a pseudo-base station apparatus which communicates with a mobile communication terminal to be tested includes display means (40) that can display information, input means (20) that can input information, scenario generation means (13) for generating the test scenario, and system information schedule generation means (111) for displaying, on the display means, a first transmission schedule setting environment with a table form that includes a plurality of setting fields which correspond to positions of a plurality of frames that can be allocated to transmission of system information in mobile communication and to which a type name of the system information can be set, receiving the type name which is input to the setting field corresponding to the position of the frame selected by the input means, and generating a transmission schedule of the system information on the basis of the input result. The scenario generation means generates the test scenario in which a communication sequence related to the system information is described on the basis of the generated transmission schedule of the system information.

In the invention, the transmission schedule of the system information can be set in the first transmission schedule setting environment with a table form including the plurality of setting fields which correspond to the positions of the plurality of frames that can be allocated to the transmission of the system information and to which the type name of the system information can be set. Therefore, it is possible to improve efficiency in setting. Since the test scenario in which a communication sequence related to the system information between a pseudo-base station apparatus and a mobile communication terminal is described is automatically generated on the basis of at least the generated transmission schedule of the system information, it is possible to improve efficiency in creating a test scenario.

The system information schedule generation means may display the first transmission schedule setting environment with a table form in which the plurality of setting fields are arranged in a matrix such that a frame number increases in any one of a row direction and a column direction.

According to this structure, it is possible to view the entire first transmission schedule setting environment at a glance and save the trouble of repeatedly scrolling the screen in order to view the entire first transmission schedule setting environment. Therefore, efficiency in setting the system information transmission schedule is improved.

The system information schedule generation means may display the first transmission schedule setting environment with a table form in which the number of setting fields in the row direction or the column direction in which the frame number increases is a multiple of n/2, where n is the number of frames which is the transmission cycle of a type of system information in which a frame allocation position is fixed to a periodic position by a communication protocol.

According to this structure, when a transmission schedule is set to a type, such as an MIB in which a frame allocation position is fixed to a periodic position by the communication protocol, the name of the type may be similarly input to a plurality of setting fields belonging to a specific row or column. Therefore, the efficiency in setting is improved.

The system information schedule generation means may display, on the display means, a second transmission schedule setting environment with a table form in which a frame period with which the system information is transmitted and the allocation position of the transmission frame in the frame period can be set so as to correspond to each type of the system information, receive the frame period and the allocation position input by the input means, and generate the transmission schedule of the system information.

According to this structure, it is possible to set the transmission schedule using a method different from that in the first transmission schedule setting environment.

The system information schedule generation means may display the second transmission schedule setting environment and the first transmission schedule setting environment at the same time and apply an input to one of the first transmission schedule setting environment and the second transmission schedule setting environment to the other transmission schedule setting environment.

According to this structure, when checking the settings of the transmission schedule, the scenario creator checks the settings of two transmission schedule setting environments. Therefore, check accuracy is expected to be improved.

The type of the system information may include plural types of system information blocks (SIBs) including system information and one type of master information block (MIB) including information about the allocation position of the system information block in the system information. The scenario generation device may further include an automatic MIB generation unit (113) that generates the content of the master information block on the basis of the generated transmission schedule of the system information. The scenario generation means may generate the test scenario using the generated master information block.

According to this structure, when the scenario creator creates a test scenario, the content of the master information block is automatically generated. Therefore, efficiency in creating the test scenario is improved.

In order to achieve the above-mentioned object, according to another aspect of the invention, there is provided a scenario generation method for generating a test scenario used in a pseudo-base station apparatus which communicates with a mobile communication terminal to be tested. The scenario generation method includes a step of displaying a first transmission schedule setting environment with a table form that includes a plurality of setting fields which correspond to positions of a plurality of frames that can be allocated to transmission of system information in mobile communication and in which a type name of the system information can be set, a step of receiving the type name which is input to the setting field corresponding to the position of the selected frame, a step of generating a transmission schedule of the system information on the basis of the input result, and a step of generating the test scenario in which a communication sequence related to the system information is described on the basis of the generated transmission schedule of the system information.

### Advantage of the Invention

According to the invention, it is possible to generate a system information transmission schedule with high efficiency and improve efficiency in generating a test scenario.

### BRIEF DESCRIPTION OF THE DRAWINGS

FIG. 1 is a block diagram illustrating the functional structure of a scenario generation device according to an embodiment of the invention.

FIG. 2 is a diagram illustrating the initial state of a first transmission schedule setting environment used by the scenario generation device shown in FIG. 1.

FIG. 3 is a diagram illustrating an example of a pull-down menu for selecting the type of system information used in the first transmission schedule setting environment shown in FIG. 2.

FIG. 4 is a diagram illustrating an example of a pull-down menu which is used in the first transmission schedule setting environment shown in FIG. 2 and can select the type of system information in each column.

FIG. 5 is a diagram illustrating an example of the first transmission schedule setting environment in which the setting of a type name to type name setting fields of a plurality of information setting fields in each column shown in FIG. 4 is completed.

FIG. 6 is a diagram illustrating the first transmission schedule setting environment in which the setting of a transmission schedule is completed.

FIG. 7 is a diagram illustrating a modification of a method of displaying the first transmission schedule setting environment shown in FIG. 6.

FIG. 8 is a diagram illustrating a specific example of a second transmission schedule setting environment.

FIG. 9 is a diagram illustrating a modification of the second transmission schedule setting environment shown in FIG. 8.

FIG. 10 is a diagram illustrating a modification of the first transmission schedule setting environment shown in FIG. 2.

FIG. 11 is a diagram illustrating another modification of the first transmission schedule setting environment shown in FIG. 2.

### BEST MODE FOR CARRYING OUT THE INVENTION

Hereinafter, embodiments of the invention will be described with reference to the drawings.

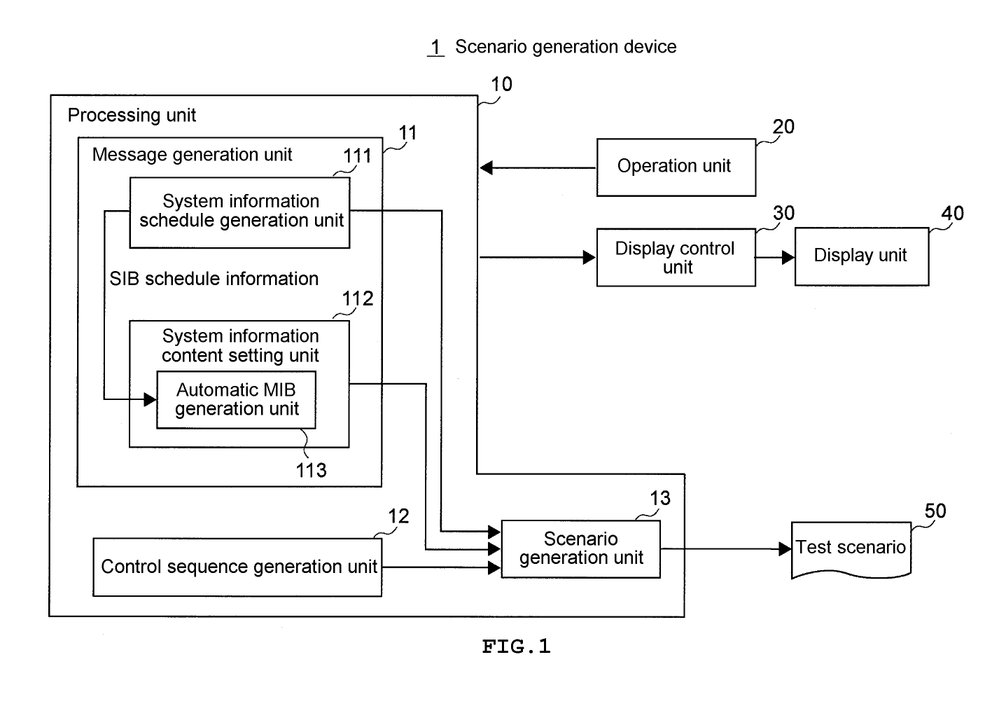

FIG. 1 is a block diagram illustrating the functional structure of a scenario generation device according to an embodiment of the invention.

A scenario generation device 1 includes a processing unit 10, an operation unit 20, a display control unit 30, and a display unit 40.

The processing unit 10 generates a test scenario 50 used in a test device that operates as a pseudo-base station of a mobile communication terminal and tests the operation of the mobile communication terminal, and includes a hardware component of a computer including, for example, a central processing unit (CPU), a main memory, and an input/output interface and a software component which is a scenario generation program.

The processing unit 10 includes, as functional elements, a message generation unit 11, a control sequence generation unit 12, and a scenario generation unit 13.

The message generation unit 11 generates various messages which are distributed from the test device to the mobile communication terminal. One of the messages which are distributed from the test device to the mobile communication terminal is system information. The message generation unit 11 includes a system information schedule generation unit 111 which sets a transmission schedule of the system information and the content of each kind of system information and a system information content setting unit 112 which sets the content of the system information. The system information content setting unit 112 includes an automatic MIB generation unit 113 which automatically sets the content of an MIB on the basis of an SIB transmission schedule set by the system information schedule generation unit 111.

In the message generation unit 11, specifically, the system information schedule generation unit 111 outputs information about a tabular transmission schedule setting environment which is used in supporting the generation of the system information transmission schedule by a test scenario creator (hereinafter, referred to as a “scenario creator”) to the display control unit 30 and the tabular transmission schedule setting environment is displayed on the display unit 40. Then, when the scenario creator uses the operation unit 20 to input information to the tabular transmission schedule setting environment displayed on the display unit 40, the system information schedule generation unit 111 generates a system information transmission schedule on the basis of the input information.

Specifically, the system information content setting unit 112 supplies, to the display control unit 30, the information about a content setting environment which is used in supporting the setting of the content of the system information by the scenario creator and a system information content setting environment is displayed on the display unit 40. Then, when the scenario creator uses the operation unit 20 to input information to the content setting environment displayed on the display unit 40, the system information content setting unit 112 sets the content of the system information on the basis of the input information.

The control sequence generation unit 12 generates a control sequence through which the test device communicates with the mobile communication terminal.

The scenario generation unit 13 generates a test scenario 50 which is related to a system information communication sequence and is described by a predetermined script language, on the basis of various messages which include the system information transmission schedule and the content of the system information and are generated by the message generation unit 11 and the control sequence generated by the control sequence generation unit 12.

Among the structures other than the processing unit 10 in the scenario generation device 1, the display control unit 30 generates data to be displayed on the display unit 40 from information about the tabular transmission schedule setting environment and the content setting environment output from the system information schedule generation unit 111. The display unit 40 includes a display screen and visually displays the display data supplied from the display control unit 30 on the screen. The operation unit 20 is input means, such as a mouse or a keyboard which can be operated by the user.

The scenario generation program is stored in a storage device (not shown), such as a hard disk drive, and is loaded to the main memory in response to a start instruction which is input from the user through the operation unit 20. The CPU reads the scenario generation program loaded to the main memory and executes the scenario generation program. That is, the scenario generation program can be introduced as an application program to a computer such as a personal computer. In order to enable the scenario generation program to be introduced into the computer, the scenario generation program can be recorded on a storage medium, such as a digital versatile disk (DVD) or a Blu-ray disc (registered trademark), and then distributed. Alternatively, the scenario generation program can be downloaded from a server apparatus through the Internet and then distributed.

(Operation of Scenario Generation Device 1)

In the scenario generation device 1, the system information schedule generation unit 111 generates the system information transmission schedule. This process is performed using the tabular transmission schedule setting environment (hereinafter, referred to as a “first transmission schedule setting environment”) which is presented to the display unit 40 by the system information schedule generation unit 111, on the basis of an operation input from the operation unit 20 by the scenario creator.

When the system information transmission schedule is generated using the first transmission schedule setting environment with a table form, the scenario creator can operate the operation unit 20 to generate the system information transmission schedule. The detailed structure of the first transmission schedule setting environment and a detailed method for generating the transmission schedule using the first transmission schedule setting environment will be described below.

When the first transmission schedule setting environment is displayed on the display unit 40, the scenario creator can operate the operation unit 20 to input an instruction to select system information whose content is desired be set and an instruction to call the content setting environment for the selected system information. The system information content setting unit 112 receives the instructions and displays the content setting environment for the selected system information on the display unit 40. When the scenario creator operates the operation unit 20 to input various parameters to the content setting environment, the system information content setting unit 112 receives these parameters as the settings of the system information.

The settings of the system information include, for example, an area range, a user equipment (UE) mode/state in which a block is valid, an UE mode/state in which a block is read, scheduling information (for example, the position of the SIB and a repetition interval), and the correction of system information.

After the generation of the system information transmission schedule, the setting of the content of the system information, and the generation of the communication sequence by the control sequence generation unit 12 are completed in this way, the scenario creator can operate the operation unit 20 to input an instruction to generate the test scenario 50. When receiving the instruction to generate the test scenario 50, the scenario generation unit 13 generates the test scenario 50 on the basis of the system information transmission schedule, the content of the system information, and the communication sequence.

(Description of First Transmission Schedule Setting Environment)

Next, the outline of the first transmission schedule setting environment will be described.

In the first transmission schedule setting environment according to this embodiment, an information setting field includes a frame number field in which a frame number indicating the position of a frame that can be allocated to the transmission of the system information is displayed and a type name setting field which can receive the type name of the system information set by the scenario creator.

For example, in the W-CDMA system, the system information is circularly broadcasted in a unit of 128 frames and one block is allocated to every other frame and is then transmitted. Therefore, the number of information setting fields is 64.

When 64 information setting fields are all displayed in one row or one column, it is difficult to refer to all of the information setting fields, without a scroll operation, due to, for example, restrictions in a screen size. Therefore, in this embodiment, all information setting fields are arranged in a matrix and the entire table is likely to be put into the screen. Therefore, browsability is improved and efficiency in setting the transmission schedule is improved.

In the W-CDMA communication standard, the MIB is allocated to the first frame (frame number=0) among 128 frames and is then transmitted. Thereafter, one MIB is transmitted in a cycle of eight frames. In this embodiment, as such, the tabular structure (the number of rows and the number of columns) of the first transmission schedule setting environment is optimized, with the transmission cycle of the MIB in consideration.

That is, in the table form of the first transmission schedule setting environment, the frame number increases in the row direction. Further, the number of information setting fields, which correspond to one row (or one column) and are arranged in the order of the frame numbers, is a multiple of n/2 (where n is the number of frames which is a transmission cycle of the MIB). For example, since the number of frames, which is the transmission cycle of the MIB, is 8, a multiple of 4 is the number of information setting fields corresponding to one row (or one column). Therefore, each information setting field in which the MIB will be set according to the communication protocol is arranged in a specific column (or row) of the table. As a result, browsability is improved and efficiency in setting the transmission schedule is improved.

Next, a detailed example of the first transmission schedule setting environment will be described.

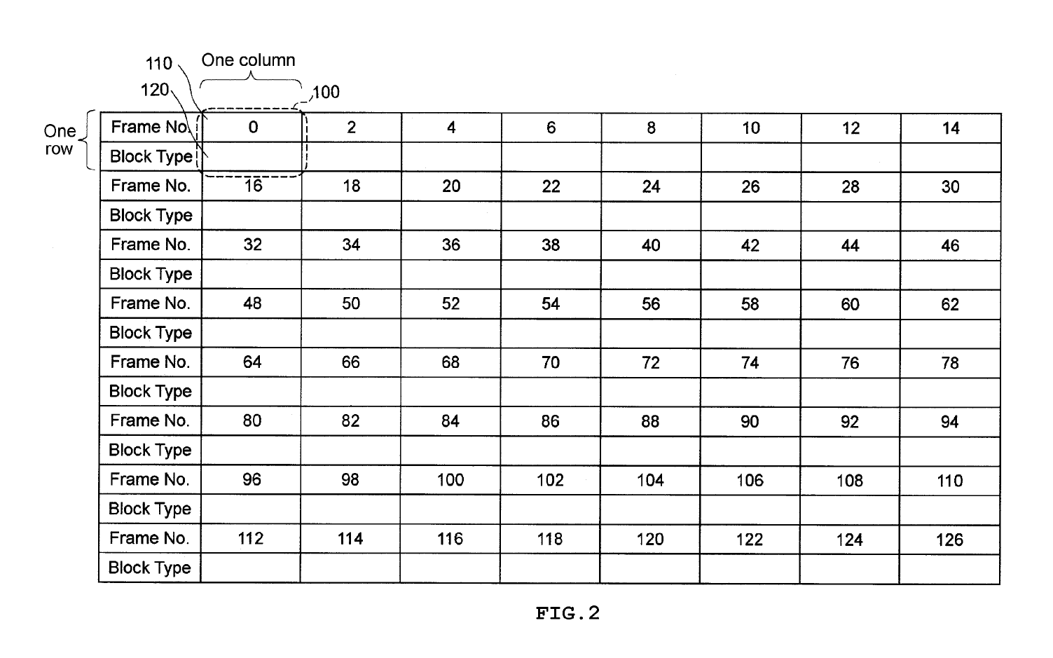

FIG. 2 is a diagram illustrating the initial state of the first transmission schedule setting environment.

As a specific example, one information setting field 100 includes a frame number field 110 which is a frame number (Frame No.) display field and a type name setting field 120 which is a system information type name (Block Type) setting field. The information setting field 100 is an element in a matrix. The number of information setting fields 100 (the number of columns) corresponding to one row is 8 and the number of information setting fields 100 (the number of rows) corresponding to one column is 8. In the table form, the frame number increases in the row direction. That is, frame number 0 is allocated to the information setting field 100 at the left end of the first row in the matrix and frame numbers 2, 4, 6, 8, 10, 12, and 14 are sequentially allocated to the remaining seven information setting fields 100 in the row from the left end. Then, similarly, frame numbers 16, 18, 20, 22, 24, 26, 28, and 30 are sequentially allocated to the information setting fields 100 in the next row from the left end. The frame numbers are similarly allocated to the next rows. Then, frame number 126 is allocated to the information setting field 100 at the right end of the bottom row.

In the initial state shown in FIG. 2, the type name setting fields 120 of all of the information setting fields 100 are blank such that the scenario creator can recognize at a glance that the setting of the type name has not been completed. Alternatively, a mark indicating that the type name has not been set may be displayed.

Next, a method for operating the first transmission schedule setting environment will be described.

Basically, the first transmission schedule setting environment is operated as follows. The scenario creator operates the operation unit 20 to select the information setting field 100 in which the type name of the system information is desired to be set. Then, the scenario creator operates the operation unit 20 to input a type name to the type name setting field 120 of the selected information setting field 100. The scenario creator repeatedly performs this operation.

The following methods are prepared in order to input the type name to the type name setting field 120:

Method 1 in which the scenario creator uses a keyboard, which is the operation unit 20, to directly input the text code of the type name;

Method 2 in which the scenario creator uses a pull-down menu to input the type name to each type name setting field 120; and

Method 3 in which the scenario creator uses a pull-down menu for each column to arrange the type names and inputs the type names.

Method 2 and method 3 which use the pull-down menu to input the type name will be described.

(Details of Method 2)

First, the scenario creator uses a mouse or a keyboard, which is the operation unit 20, to select the information setting field 100 with the frame number in which the type name of the system information is desired to be set. Specifically, for example, the scenario creator performs a click operation to select the type name setting field 120 of the information setting field 100. The system information schedule generation unit 111 receives the information generated by the selection operation and displays a pull-down menu for selecting the type name of system information so as to be associated with the type name setting field 120.

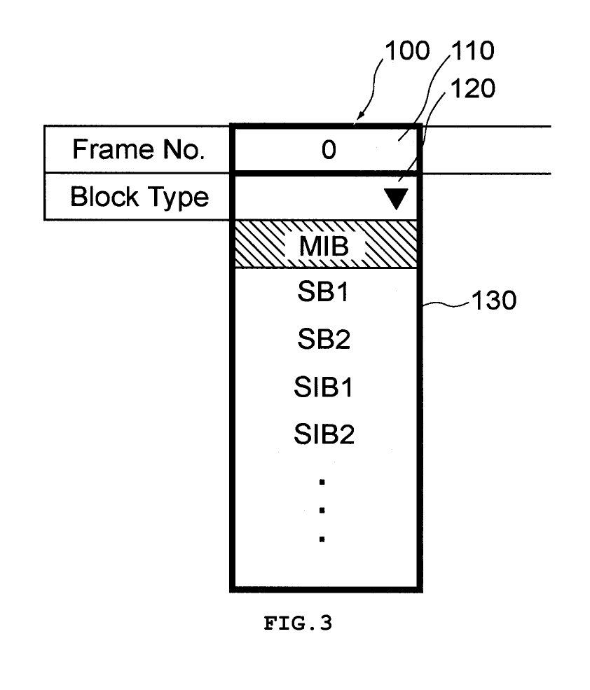

FIG. 3 is a diagram illustrating an example of a pull-down menu 130 for selecting the type name of system information.

A list of the type names of the system information is displayed in the pull-down menu 130. It is preferable that the type names of the system information be sequentially displayed in a hierarchical order from the upper side in the pull-down menu. For example, it is preferable that the type names of the system information be displayed in the order of MIB, SB1, SB2, SIB1, SIB2, from the upper side.

The scenario creator can operate the operation unit 20 to select any one of the type names in the pull-down menu 130. The system information schedule generation unit 111 receives information generated by the selection operation, stores the selected type name in the main memory so as to be associated with the frame number, and displays the selected type name in the type name setting field 120 of the information setting field 100.

The function of selecting the type name using the pull-down menu 130 is similarly applied to the type name setting fields 120 of all of the information setting fields 100 in the first transmission schedule setting environment. Therefore, the scenario creator can repeatedly perform the operation of selecting the type name using the pull-down menu 130 for each information setting field 100 in the first transmission schedule setting environment to complete the generation of the system information transmission schedule.

As such, method 2 which inputs the type name to each type name setting field 120 using the pull-down menu 130 is a reliable method which can input the type name for each frame number.

(Details of Method 3)

Next, method 3 which arranges and inputs the type names for each column using the pull-down menu 130 will be described.

Method 3 puts emphasis on efficiency.

As described above, in the table form of the first transmission schedule setting environment according to this embodiment, the frame number increases in the row direction and the number of information setting fields 100 which correspond to one row and are arranged in the order of the frame numbers is a multiple of n/2 (where n is the number of frames which is the transmission cycle of the MIB). Therefore, each information setting field 100 in which the MIB will be set is aligned in a specific column of the table. In addition, among other types of blocks, the frame position to which a given block is transmitted is determined on the basis of the frame position to which the MIB is transmitted. In some cases, the information setting field 100 in which this type of block will be set is also aligned with a specific column of the table. Method 3 is suitable when the same type name is set for each column.

First, the scenario creator uses a mouse or a keyboard, which is the operation unit 20, to select all of the information setting fields 100 belonging to the column in which the type name of the system information is desired to be set. The system information schedule generation unit 111 receives information generated by the selection operation and displays a pull-down menu for selecting the type of system information so as to be associated with the selected column.

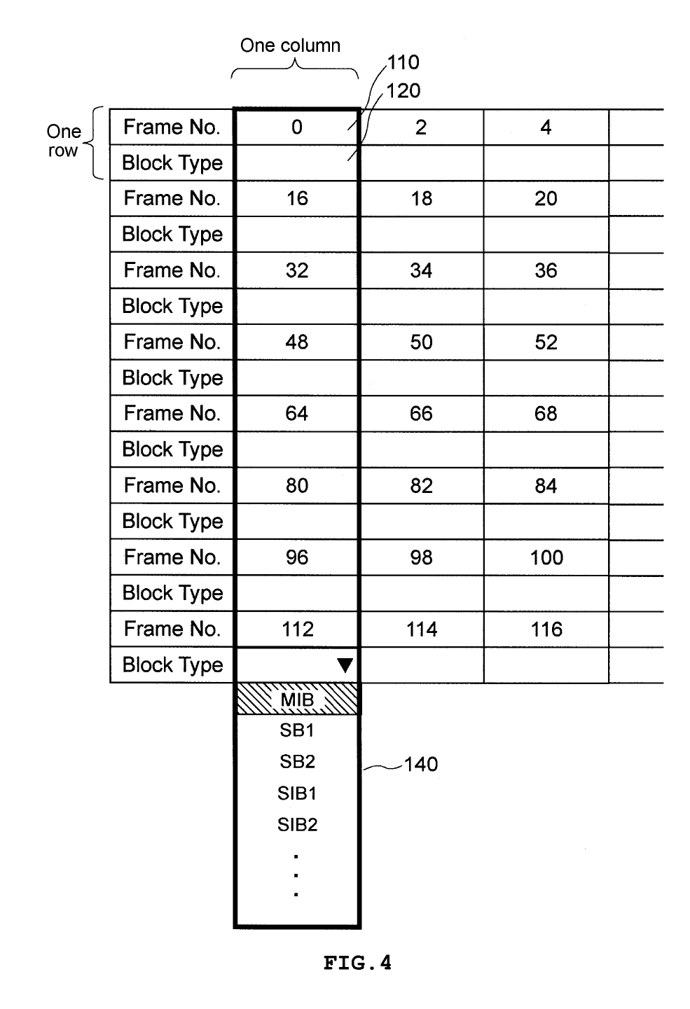

FIG. 4 is an example of the display of a pull-down menu 140 which can select the type of system information for each column.

The structure of the pull-down menu 140 may be the same as that of the pull-down menu 130 for each type name setting field 120 shown in FIG. 3.

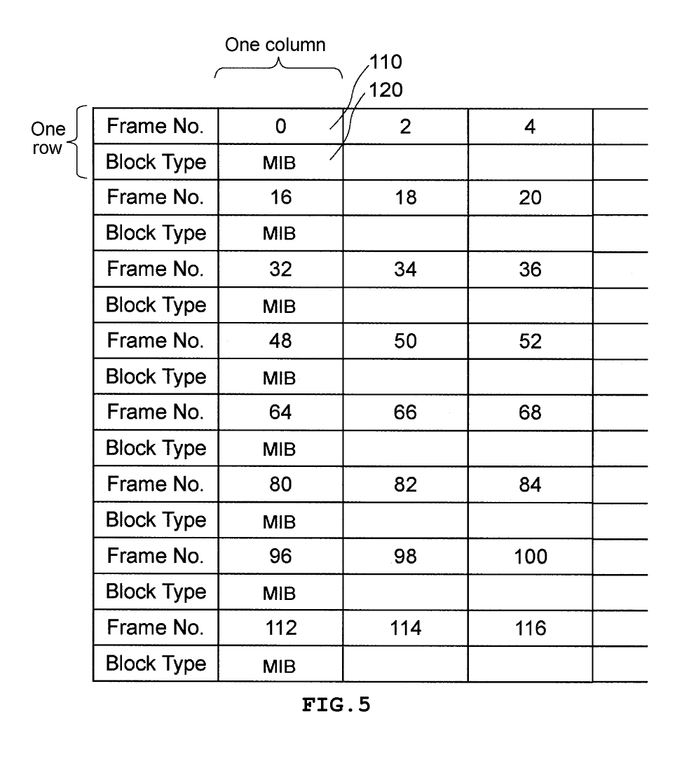

The scenario creator can operate the operation unit 20 to select an arbitrary type name in the pull-down menu 140. The system information schedule generation unit 111 receives information generated by the selection operation, stores the selected type name in the main memory so as to be associated with each frame number belonging to the column, and displays the type name in each of the type name setting field 120 of a plurality of information setting fields 100 belonging to the column. FIG. 5 shows an example of the first transmission schedule setting environment in which the setting of the type name to each of the type name setting fields 120 of a plurality of information setting fields 100 belonging to each column is completed. FIG. 5 shows a case in which “MIB” is set as the type name to each of the type name setting fields 120 of a plurality of information setting fields 100 belonging to the leftmost column.

The method of inputting the type name to the type name setting field 120 of the information setting field 100 has been described above. However, the input type name can be changed by, for example, a direct input method based on method 1 at any time.

Therefore, the type name can be set such that, after the type name is set for each column by method 2, the type name input to the type name setting fields 120 of some of the information setting fields 100 is changed by the direct input method based on method 1.

The unit of a target to which the type name can be input by the pull-down menu 130 or 140 may be a plurality of information setting fields 100 which are continuous in the column direction, in addition to each information setting field 100 and each column.

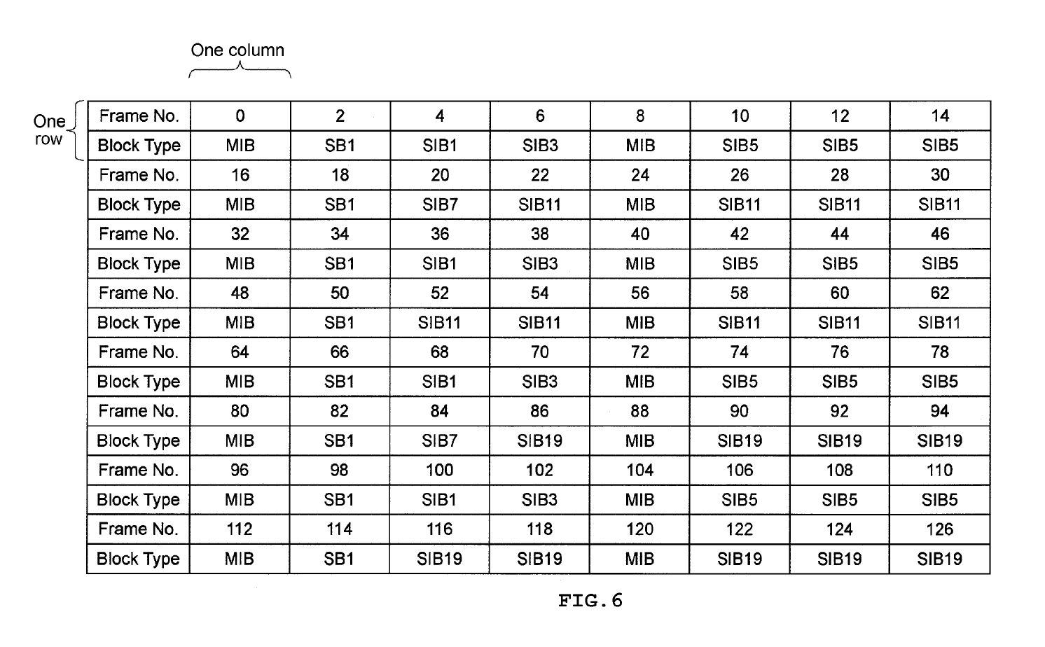

FIG. 6 shows an example of the first transmission schedule setting environment in which methods 1 to 3 are selectively used to complete the setting of the type name of the system information to all frame positions, that is, the setting of the transmission schedule.

In this example, “MIB” is set as the type name in the type name setting field 120 of each of the information setting fields 100 belonging to the first and fifth columns from the left side of each row. As such, when the type name of the MIB in which the allocation position of a transmission frame is periodically fixed by the communication standard is set, it is possible to collectively set the type name for each column. In addition, in a type in which the allocation position of the transmission frame is determined on the basis of the transmission position of the MIB, similarly, it is possible to correctively set the type name for each column. Therefore, it is possible to significantly improve the overall setting efficiency. For example, in the example shown in FIG. 6, the SB1 is set to the second column from the left end.

Each specific type of information setting field 100 may be displayed in a different color such that the scenario creator can easily recognize a difference in type when checking the generated transmission schedule.

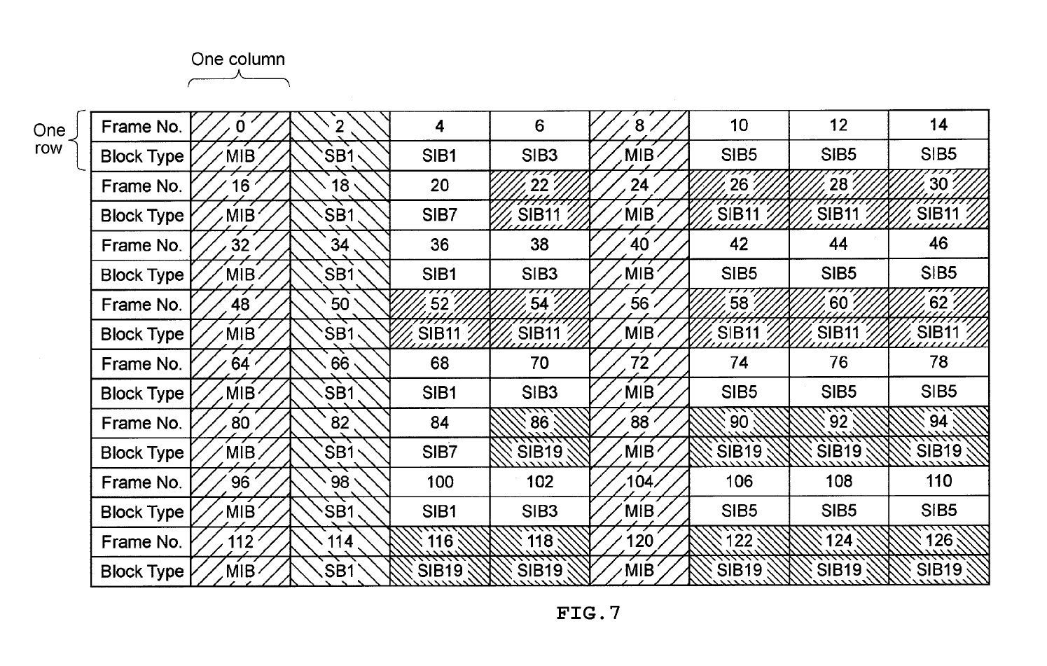

FIG. 7 shows an example in which at least one of the background color and letters of each type of information setting fields 100 of “MIB”, “SB1”, “SIB11”, and “SIB19” as the type name is displayed in the same color. The scenario creator may arbitrarily set the color to be allocated to each type name. In this case, colors are not necessarily allocated to all types.

(For Automatic MIB Generation Unit 113)

Next, the automatic MIB generation unit 113 will be described in detail.

The automatic MIB generation unit 113 automatically sets the content of the MIB on the basis of the transmission schedule of the SIB set by the system information schedule generation unit 111.

Next, an automatic MIB generation operation of the automatic MIB generation unit 113 will be described.

The MIB is formed by schedule information indicating the frame number to which one or more SIBs which are transmitted with the frame are allocated. Specifically, the MIB includes information about an allocation position (SIB#POS) indicating the transmission cycle (SIB#REP) of the SIB and the number of the block which is transmitted as the SIB in the period defined by the value of the transmission cycle (SIB#REP). Therefore, when all frame positions of the SIBs from the frame position at which an MIB is transmitted to the frame position at which the next MIB is transmitted are set, the content of the MIB is automatically determined.

That is, as described above, the automatic MIB generation unit 113 acquires the schedule information (frame number) of one or more SIBs which are set from the frame position at which an MIB is transmitted to the frame position at which the next MIB is transmitted from the system information schedule generation unit 111. The automatic MIB generation unit 113 automatically generates the content of the MIB on the basis of the acquired schedule information (frame number) of one or more SIBs. When the content of the MIB is completed by the input from the scenario creator before the schedule information (frame number) of the SIB is set, the automatic MIB generation unit 113 compares the automatically-generated content of the MIB with the input content. When the generated content is not identical to the input content, the automatic MIB generation unit 113 outputs a warning. The warning process is performed by a method in which the scenario creator can recognize the warning. For example, in the first transmission schedule setting environment and the content setting environment, a method of displaying the warning is used.

The automatic MIB generation makes it possible to improve the efficiency and accuracy of setting the content of the MIB.

(Modification 1)

In modification 1, separately from the first transmission schedule setting environment, a new transmission schedule setting environment in which, for example, a transmission cycle, the number of divided blocks, and an allocation position are input for each type of system information to set a system information transmission schedule is introduced as a second transmission schedule setting environment. The second transmission schedule setting environment and the first transmission schedule setting environment can be simultaneously or alternately displayed on the display unit 40.

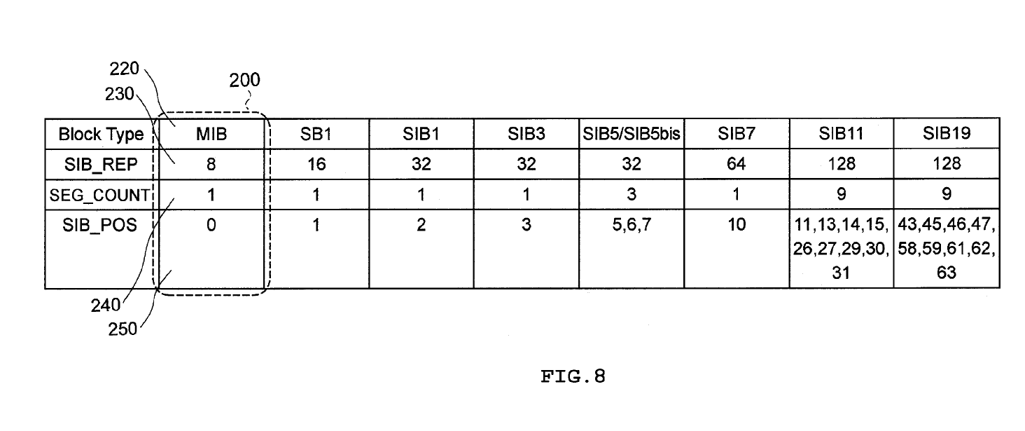

FIG. 8 is a diagram illustrating a detailed example of the second transmission schedule setting environment.

As shown in FIG. 8, in the second transmission schedule setting environment, one information setting field 200 includes a system information type name (Block Type) setting field 220, a transmission cycle (SIB#REP) setting field 230, a divided block number (SEG#COUNT) setting field 240, and an allocation position (SIB#POS) setting field 250.

The transmission cycle (SIB#REP) is a value indicating the frame period in which a block with the type name set to the type name setting field 220 is transmitted.

The number of divided blocks (SEG#COUNT) is a value indicating the number of blocks which are divided from the content of the block with the type name set to the type name setting field 220 for transmission.

The allocation position (SIB#POS) indicates the transmission number of the block with the type name set to the type name setting field 220 in the period which is defined by the value of the transmission cycle (SIB#REP). The value of the allocation position (SIB#POS) is not the number of frames, but is ((the number of frames)÷2). This is because the block of the system information is transmitted in a cycle of two frames.

In the detailed example of the second transmission schedule setting environment shown in FIG. 8, for example, when attention is paid to the information setting field 200 having a type name “MIB” set thereto, the transmission cycle (SIB#REP) is 8, the number of divided blocks (SEG#COUNT) is 1, and the allocation position (SIB#POS) is 0.

This shows the content of settings in which the MIB is transmitted in a cycle of eight frames, the content thereof is not divided, but is transmitted by one frame, and the MIB is transmitted as the first frame (frame number 0) among eight frames.

When attention is paid to the information setting field 200 with a type name “SIB5/SIB5bis”, the transmission cycle (SIB#REP) is 32, the number of divided blocks (SEG#COUNT) is 3, and the allocation position (SIB#POS) is 5, 6, and 7.

This shows the content of settings in which system information with the type name “SIB5/SIB5bis” is transmitted in a cycle of 32 frames, the content thereof is divided into three blocks and is then transmitted, and the three blocks are transmitted in the sixth, seventh, and eighth frames (frame numbers 5, 6, and 7) from the first frame (frame number 0) among 32 frames, respectively.

As such, for example, since the second transmission schedule setting environment in which the transmission cycle, the number of divided blocks, and the allocation position are input for each type of system information to set the system information transmission schedule is introduced, it is possible to set the transmission schedule using a method different from that used in the first transmission schedule setting environment.

The divided block number setting field in the second transmission schedule setting environment is not necessarily used in order to set the allocation position of the block.

Information about the first transmission schedule setting environment and information about the second transmission schedule setting environment are synchronously input. That is, the system information schedule generation unit 111 replaces information input to the first transmission schedule setting environment with equivalent information in the second transmission schedule setting environment and inputs the information items to the second transmission schedule setting environment at the same time. Similarly, the system information schedule generation unit 111 replaces information input to the second transmission schedule setting environment with equivalent information in the first transmission schedule setting environment and inputs the information items to the first transmission schedule setting environment at the same time. Therefore, when checking the settings of the transmission schedule, the scenario creator checks the settings of two transmission schedule setting environments. As a result, check accuracy is expected to be improved.

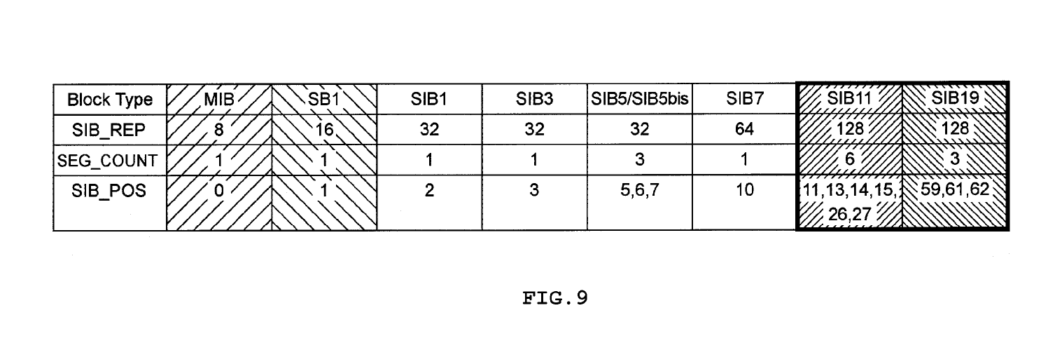

In the second transmission schedule setting environment, for example, as shown in FIG. 9, a specific type of information setting field 200 may be displayed in a different color for each type such that it can be distinguished. In this case, it is preferable that the relationship between a type and a color be identical between two transmission schedule setting environments. In addition, the pull-down menu may be used to input a value to the system information type name (Block Type) setting field 220.

The system information schedule generation unit 111 can switch and display the first transmission schedule setting environment and the second transmission schedule setting environment or can display them at the same time, in response to instructions from the scenario creator through the operation unit 20.

(Modification 2)

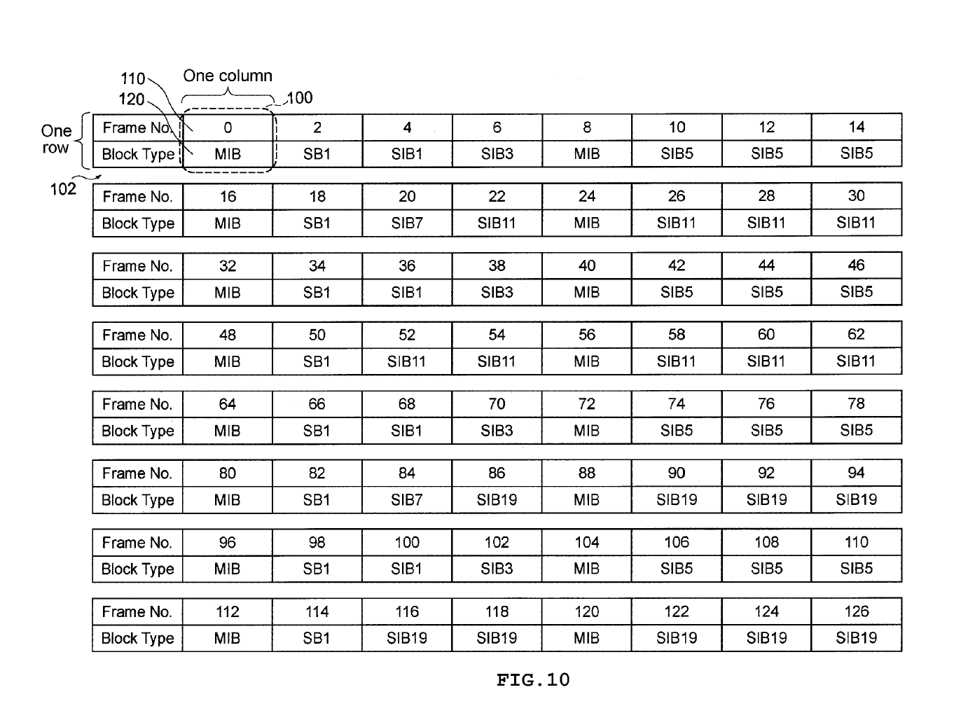

FIG. 10 is a diagram illustrating a modification of the first transmission schedule setting environment.

In the first transmission schedule setting environment with a matrix structure shown in FIG. 2, one information setting field 100 is an element in the matrix. However, the information setting field 100 includes the frame number field 110, and the type name setting field 120. The frame number field 110 and the type name setting field 120 are vertically arranged. Therefore, it is difficult to easily recognize the boundary between rows. Therefore, in this modification, a space 102 is provided between the rows having the information setting field 100 as an element in the matrix, which makes it easy to recognize the boundary between the rows.

In addition, in order to easily recognize the boundary between the rows, a line which separates the rows may be different in type or color in the frame number field and the type name field.

(Modification 3)

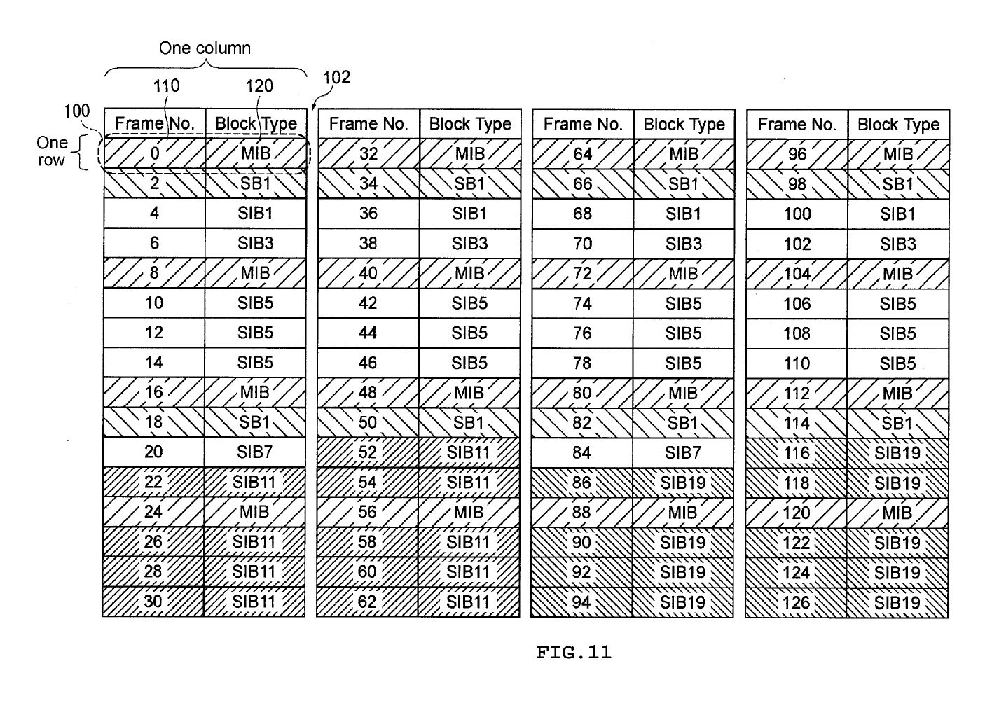

FIG. 11 is a diagram illustrating another modification of the first transmission schedule setting environment.

In another modification of the first transmission schedule setting environment, the frame number field 110 and the type name setting field 120 are arranged in the row direction in the information setting field 100. The number of information setting fields 100 (the number of rows) in one column is “16” and the number of information setting fields 100 (the number of columns) in one row is “4”.

In this modification of the first transmission schedule setting environment, the frame number increases in the column direction. That is, frame number 0 is allocated to the top information setting field 100 in the leftmost column and frame numbers 2, 4, 6, 8, 10, 12, 14, 16, 18, 20, 22, 24, 26, 28, and 30 are sequentially allocated to the remaining seven information setting fields 100 in the column. Similarly, frame numbers 32, 34, 36, 38, 40, 42, 44, 46, 48, 50, 52, 54, 56, 58, and 60 are sequentially allocated to the information setting fields 100 in the next column from the top. Frame numbers are allocated to the information setting fields in the subsequent columns by the same method. Then, frame number 126 is allocated to the bottom information setting field 100 in the rightmost column.

According to this modification of the first transmission schedule setting environment, since each column includes 32 frames, in the settings based on the W-CDMA communication protocol, the content of the type name setting fields 120 of the first, fifth, ninth, and thirteenth information setting fields 100 from the upper side in each column is “MIB”. Therefore, when the same menu as the pull-down menu 140 shown in FIG. 4 is displayed with each row selected, the scenario creator can select a type name from the menu to set the type name arranged in each row. In the example shown in FIG. 11, since system information items, such as “SB1”, “SIB1”, “SIB3”, and “SIB5/SIB5bis”, are horizontally arranged for each type, the scenario creator can select the type name from the menu to set the type name for each row.

In the information setting field 100, since the frame number field 110 and the type name setting field 120 are horizontally arranged, a space 102 is provided between the columns such that the boundary between the columns is easily recognized. In addition, in this table form, each type of system information may be displayed in a different color.

(Modification 4)

In the first transmission schedule setting environment, the number of rows and the number of columns may be fixed in the system, with the restrictions in the communication protocol in consideration and may be changed depending on the number of rows and the number of columns which are designated by the scenario creator through the operation unit 20.

[Supplementary Note]

In the above description, since the W-CDMA system is given as an example, a “frame” is used as the unit of the system information transmission schedule. However, when the invention is applied to an LTE system, the “frame” may be replaced with a “sub-frame” which is the unit of schedule in the LTE system.

The invention is not limited to the above-described embodiment, but various modifications and changes of the invention can be made without departing from the scope and spirit of the invention.

### DESCRIPTION OF REFERENCE NUMERALS AND SIGNS

1: SCENARIO GENERATION DEVICE
10: PROCESSING UNIT
11: MESSAGE GENERATION UNIT
12: CONTROL SEQUENCE GENERATION UNIT
13: SCENARIO GENERATION UNIT
20: OPERATION UNIT
30: DISPLAY CONTROL UNIT
40: DISPLAY UNIT
111: SYSTEM INFORMATION SCHEDULE GENERATION UNIT
112: SYSTEM INFORMATION CONTENT SETTING UNIT
113: AUTOMATIC MIB GENERATION UNIT

What is claimed is:

1. A scenario generation device for generating a test scenario used in a pseudo-base station apparatus which communicates with a mobile communication terminal to be tested comprising:
display means that can display information;
input means that can input information;
scenario generation means for generating the test scenario; and
system information schedule generation means for displaying, on the display means, a first transmission schedule setting environment with a table form that includes a plurality of setting fields which correspond to positions of a plurality of frames that can be allocated to transmission of system information in mobile communication and to which a type name of the system information can be set, receiving the type name which is input to the setting field corresponding to the position of the frame selected by the input means, and generating a transmission schedule of the system information on the basis of the input result,
wherein the scenario generation means generates the test scenario in which a communication sequence related to the system information is described on the basis of the generated transmission schedule of the system information.

2. The scenario generation device according to claim 1,
wherein the system information schedule generation means displays the first transmission schedule setting environment with a table form in which the plurality of setting fields are arranged in a matrix such that a frame number increases in any one of a row direction and a column direction.

3. The scenario generation device according to claim 2,
wherein the system information schedule generation means displays the first transmission schedule setting environment with a table form in which the number of setting fields in the row direction or the column direction in which the frame number increases is a multiple of n/2, where n is the number of frames which is the transmission cycle of a type of system information in which a frame allocation position is fixed to a periodic position by a communication protocol.

4. The scenario generation device according to claim 1,
wherein the system information schedule generation means displays, on the display means, a second transmission schedule setting environment with a table form in which a frame period with which the system information is transmitted and the allocation position of the transmission frame in the frame period can be set so as to correspond to each type of the system information, receives the frame period and the allocation position input by the input means, and generates the transmission schedule of the system information.

5. The scenario generation device according to claim 4,
wherein the system information schedule generation means displays the second transmission schedule setting environment and the first transmission schedule setting environment at the same time and applies an input to one of the first transmission schedule setting environment and the second transmission schedule setting environment to the other transmission schedule setting environment.

6. The scenario generation device according to claim 1,
wherein the type of the system information includes plural types of system information blocks (SIBs) including system information and one type of master information block (MIB) including information about the allocation position of the system information block in the system information,
the scenario generation device further includes an automatic MIB generation unit that generates the content of the master information block on the basis of the generated transmission schedule of the system information, and
the scenario generation means generates the test scenario using the generated master information block.

7. A scenario generation method for generating a test scenario used in a pseudo-base station apparatus which communicates with a mobile communication terminal to be tested, comprising:
a step of displaying a first transmission schedule setting environment with a table form that includes a plurality of setting fields which correspond to positions of a plurality of frames that can be allocated to transmission of system information in mobile communication and in which a type name of the system information can be set;
a step of receiving the type name which is input to the setting field corresponding to the position of the selected frame;
a step of generating a transmission schedule of the system information on the basis of the input result; and
a step of generating the test scenario in which a communication sequence related to the system information is described on the basis of the generated transmission schedule of the system information.

8. The scenario generation method according to claim 7,
wherein the display step displays the first transmission schedule setting environment with a table form in which the plurality of setting fields are arranged in a matrix such that a frame number increases in any one of a row direction and a column direction.

9. The scenario generation method according to claim 8,
wherein the display step displays the first transmission schedule setting environment with a table form in which the number of setting fields in the row direction or the column direction in which the frame number increases is a multiple of n/2, where n is the number of frames which is a transmission cycle of a type of system information in which a frame allocation position is fixed to a periodic position by a communication protocol.

10. The scenario generation method according to claim 7,
wherein the display step displays a second transmission schedule setting environment with a table form in which a frame period with which the system information is transmitted and the allocation position of the transmission frame in the frame period can be set so as to correspond to each type of the system information, and
the step of receiving the type name receives the input frame period and the input allocation position.

11. The scenario generation method according to claim 10,
wherein the display step displays the second transmission schedule setting environment and the first transmission schedule setting environment at the same time and applies an input to one of the first transmission schedule setting environment and the second transmission schedule setting environment to the other transmission schedule setting environment.

12. The scenario generation method according to claim 7,
wherein the type of the system information includes plural types of system information blocks (SIBs) including system information and one type of master information block (MIB) including information about the allocation position of the system information block in the system information,
the scenario generation method further includes a step of generating the content of the master information block on the basis of the generated transmission schedule of the system information, and
the step of generating the test scenario generates the test scenario using the generated master information block.
